(19) United States
(12) Patent Application Publication
(10) Pub. No.: US 2026/0126554 A1
(43) Pub. Date: May 7, 2026

(54) SYSTEM AND METHOD WITH FEATURE FOR ADJUSTING GPS PERFORMANCE

(71) Applicant: Dell Products L.P., Round Rock, TX (US)

(72) Inventors: Yi-Hao YEH, New Taipei City (TW); Kai-Jung CHANG, Taoyuan City (TW); P. H. LIN, Taipei City (TW); Ping-Wei LEE, New Taipei City (TW); Chu-Hsin CHENG, Baoshan Township (TW)

(73) Assignee: Dell Products L.P., Round Rock, TX (US)

(21) Appl. No.: 18/935,046

(22) Filed: Nov. 1, 2024

(51) Int. Cl. G01S 19/23; G01S 19/34; G01S 19/37

(52) U.S. Cl. CPC G01S 19/23; G01S 19/34; G01S 19/37

(57) ABSTRACT

A method and system include, among other components, a GPS receiver and one or more Universal Serial Bus (USB) ports. The GPS receiver may be implemented as a discrete device and may be located in close proximity, e.g., anywhere from 5 to 30 mm, to one or more of the USB ports. Performance data may indicate GPS performance or functionality is influenced by one more USB parameters including, USB version information, e.g., USB 2.0, USB 3.0, etc. and port proximity information indicating distance between the systems USB port and the GPS receiver or a component thereof, e.g., a GPS antenna. The system may include a circuit, module, or other component to detect GPS activity and transmit a GPS-activity signal to trigger a USB configuration that prevents USB 3.0 operation. The detection circuit may employ, e.g., an existing GPS device pin or a custom circuit configured to detect GPS power consumption.

### TECHNICAL FIELD

The present disclosure is in the field of information handling systems and, more specifically, information handling systems including a Global Positioning System (GPS) receiver.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

A disclosed method and system may include, among other components, a GPS receiver and one or more Universal Serial Bus (USB) ports. The GPS receiver may be implemented as a discrete device and may be located in close proximity, e.g., anywhere from 5 to 30 mm, to one or more of the USB ports. Performance data may indicate GPS performance or functionality is influenced by one more USB parameters including, USB version information, e.g., USB 2.0, USB 3.0, etc. and port proximity information indicating distance between the systems USB port and the GPS receiver or a component thereof, e.g., a GPS antenna. The system may include a circuit, module, or other component to detect GPS activity and transmit a GPS-activity signal to trigger a USB configuration that prevents USB 3.0 operation. The detection circuit may employ, e.g., an existing GPS device pin or a custom circuit configured to detect GPS power consumption.

In one aspect, a disclosed method for managing an information handling system determines whether a first component, e.g., a GPS receiver, of an information handling system is active and generating a component active signal indicating whether the first component is active. The method further includes configuring a communication link, e.g., a USB link, of the information handling system based, at least in part, on the component active signal.

In at least some implementations, the first component includes an antenna configured to receive radio frequency signals and performance or functionality of the first component may drop or fail when the antenna is physically located proximal to a source of electrical noise associated with the communication link, such as a connector port of the communication link. Apart from the physical proximity of the antenna and the port, the first component may be functionally unrelated with respect to the communication link.

In at least one embodiment, the detection of GPS receiver activity triggers a configuration event that effectively disables or more newer and fast USB protocols in favor of one or more older and slower USB protocols. As an illustrative example, an information handling system that supports USB 2.0 and USB 3.0 operation, GPS receive active may effectively disable the USB 3.0 protocol while permitting USB 2.0 operation to continue. In some embodiments, the feature for deliberately slowing the communication link may be enabled or disabled by a user via a setting access from a suitable interface such as a BIOS setup menu or the like. The setting may be presented to the user as an optimization setting for prioritizing GPS performance over USB performance or vice versa.

While the drawing figures and the accompanying descriptive text below emphasize disclosed features in the context of a GPS receiver and a

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a representative information handling system in which disclosed features may be beneficially deployed;

FIG. 2 illustrates a block diagram of a representative information handling system in which disclosed features may be beneficially deployed;

FIGS. 3 and 4 are flow diagram depictions of representative methods and features for managing GPS performance in an information handling system; and

FIG. 5 is a block diagram depicted of an information handling system suitable for use in conjunction with features disclosed in FIGS. 1-4.

### DETAILED DESCRIPTION

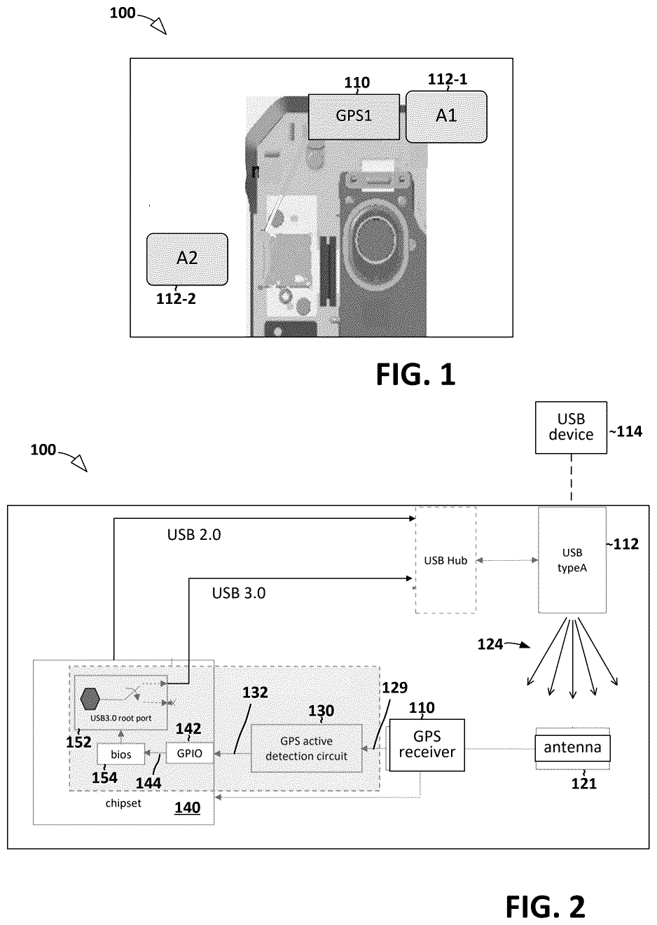

Exemplary embodiments and their advantages are best understood by reference to FIGS. 1-4, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, as applicable, whether connected indirectly or directly, with or without intervening elements.

Referring now to the drawings, FIG. 1 illustrates an information handling system 100 in which disclosed features for adjusting GPS performance may be beneficially implemented. In at least some embodiments, information handling system 100 is implemented as a laptop, tablet, or other type of mobile computing device that includes, in addition to one or more general purpose processors and memory devices (not explicitly depicted in FIG. 1), peripheral components including a GPS receiver 110 and one or more USB ports 120, of which FIG. 1 illustrates a first USB port 120-1 and a second USB port 120-2, any one or more of which may be Type A USB ports.

In at least some deployments, GPS receiver 110 may exhibit degraded performance or non-functionality due, at least in part, to the proximity of GPS receiver 110 to USB port(s) 120. In addition, in at least some scenarios, the performance and/or functionality impact on GPS receiver 110 may be influenced by one or more electrical parameters associated with a USB communication link of which USB ports 120-1 and 120-2 may be a part. As an illustrative and non-limiting example, GPS receiver 110 may exhibit negatively impacted performance when either or both of USB ports 120 is operates in compliance with any USB standard rated SuperSpeed or higher including, without limitation, USB 3.1 Gen1, formerly designated as USB 3.0, and USB 3.1 Gen2. Although FIG. 1 is not necessarily to scale, FIG. 1 conveys a density of the components around GPS receiver 110. FIG. 1 conveys a close proximity between GPS receiver 110 and USB Type A port 112-1 as well as USB Type A port 112-2.

Turning now to FIG. 2, an exemplary implementation of disclosed functionality for managing, adjusting, or otherwise configuring a GPS receiver within information handling system 100 is shown. As depicted in FIG. 2, USB port 112 enables USB device 114 and information handling system 100 to exchange data via one or more high speed serial data signals generically referred to herein as USB data signals. In at least some configurations, USB data signals traversing USB port 112 may result in electromagnetic noise 124 that may be of sufficient magnitude and frequency content to interfere with and negatively impact the performance and/or functionality of one or more other components in the vicinity of USB port 112.

The distance between USB port 112 and an antenna 121 of GPS receiver 112 may, in at least some designs, be insufficient to isolate antenna 121 from EMN 124. In such cases, the performance and/or functionality of GPS receiver 110 may be negatively impacted by electromagnetic interference attributable to a component, USB Type A port 112, that is functionally unrelated to GPS receiver 110. For example, GPS receiver 110 may be unable to resolve a geographic position of the receiver or establish a GPS-based time of day when USB port 112 is running in compliance with USB 3.0 or higher. In addition, the magnitude of the electrical noise, and the interference resulting therefrom, may be influenced by the electrical characteristics of the data signal. Comparing USB 3.0 with USB 2.0, as an illustrative example, USB 3.0 specifies a maximum signal rate that is roughly 10× the maximum signal rate for USB 2.0 and specifies a maximum delivered current that is nearly double that of USB 2.0. Accordingly, the USB port 112 depicted in FIG. 2 may generate appreciably greater electrical noise during USB 3.0 operation than it might generate during USB 2.0 operation. Anecdotal data indicates that the signal to noise ratio in the vicinity of antenna 121 is appreciably lower during USB 3.0 operation than during USB 2.0 operation. In at least some instances, the decrease in signal/noise ration during USB 3.0 operation is sufficient to render GPS receiver 110 unable to resolve its position, i.e., sufficient to render GPS receiver 112 effectively inoperable. Conversely, the same GPS receiver 112 may function perfectly adequately when the USB communication link to which port 112 is connected is executes in compliance with USB 2.0.

In at least one embodiment, disclosed features for managing GPS performance and/or functionality may prohibit or restrict USB 3.0 operation when GPS receiver 112 is active. When GPS receiver 112 is not enabled or not otherwise sufficiently active, e.g., in a sleep or other form of power conservation mode, disclosed features may permit USB 3.0 operation. In at least some scenarios, disabling USB 3.0 operation whenever GPS receiver 112 is enabled or otherwise sufficiently active may be an acceptable option, at least in part because GPS receiver solutions are often designed to “sleep” the GPS receiver as much as possible to reduce power consumption.

The information handling system 100 depicted in FIG. 2 includes a GPS active detection circuit 130 that monitors activity, health, or other information from GPS receiver 110. In the depicted implementation, GPS active detection circuit 130 receives an output signal 128 from GPS receiver 110 and determines based on output signal 128 whether GPS receiver 110 is active or sufficiently active to trigger management of the USB subsystem to limit interference 124 that may render GPS receiver inoperable.

In at least one embodiment, GPS output signal 128 may be derived directly from a pin of GPS receive 110. As an example, at least some GPS receiver devices include a low noise amplifier enable (LNA-EN) signal, also referred to as ANT ON, that can be leveraged directly to indicate GPS receiver activity. Other implementations may determine GPS activity based on an analog characteristic. For example, the GPS receiver 110 may exhibit a significant difference in power consumption between a sleep mode and an active mode. In some implementations, for example, a representative GPS receiver 110 may draw approximately 43 mW in sleep mode versus approximately 220 mW when active. Thus, GPS active detection circuit 130 may include current sensing circuitry and one or more comparators to effectively sense or calculate whether GPS receiver 110 is active and control the state of component active signal 132 accordingly. Active detection circuit 130 may generate component active signal 132 as a binary signal, simply indicating whether GPS receiver 110 is active or not active.

The component active signal 132 shown in FIG. 2 is delivered to general purpose I/O (GPIO) module 142 within a chipset 140 of information handling system 100. GPIO module 142 may produce a signal that, at least in part, controls a configuration of the USB subsystem. More specifically, the output signal 144 from GPIO module 142 may be used to disable USB 3.0 functionality. In such cases, the disabling of USB 3.0 functionality may reflect a decision to prioritize GPS receiver performance with respect to USB performance. It should be noted, however, that even though USB performance will be negatively impacted when USB 3.0 functionality is disabled, USB 2.0 functionality will persist and will enable USB communication without disabling GPS receiver functions. FIG. 2 further conveys that the output signal 144 from GPIO module 142 is not routed directly to USB 3.0 root port 152. Instead, GPIO output signal 142 is illustrated routed through a BIOS module 154. in at least some embodiments, BIOS module 154 enables a user configurable setting that either permits or prohibits GPIO output signal 144 from altering the USB configuration. This user configurable setting may be accessible from a BIOS setup menu or the like.

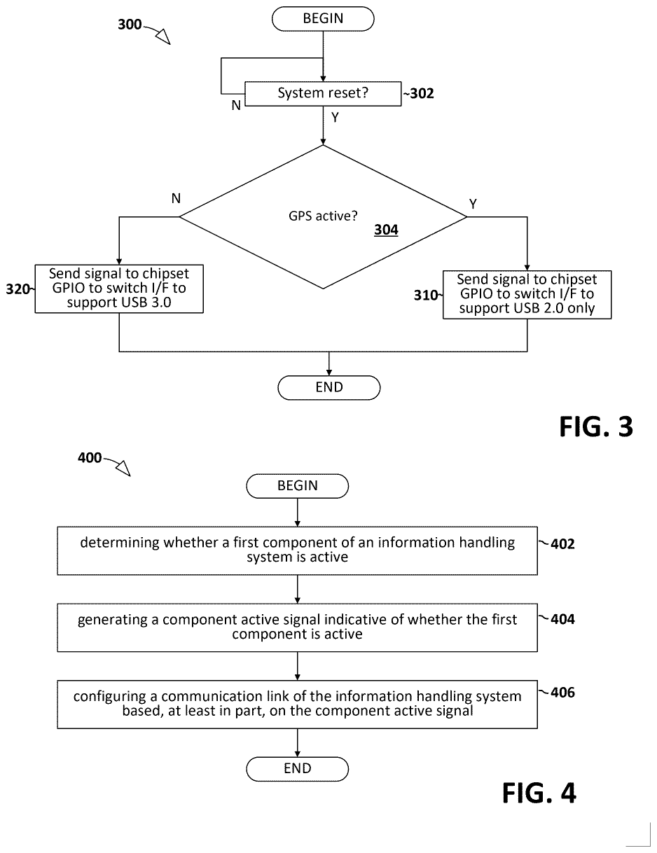

Referring now to FIG. 3, a flow diagram representation of a method 300 for managing GPS functionality in an information handling system is depicted. In the illustrated method 300, following a system reset (302), a determination (304) of GPS activity is made. If it is determined that GPS receiver is active, method 300 branches to operation 310 and sends a signal to the chipset GPIO to switch to support USB 2.0 only. If is determined that the GPS receiver is not active, method 200 branches to operation 320 and sends a signal to the chipset GPO to switch the interface to support USB 3.0 operation.

Turning now to FIG. 4, a flow diagram of a method for managing an information handling system component is depicted. Method 400 reflects that, although this disclosure has relied on examples involving GPS receivers and USB connection ports, those are implementation details that can be readily extended to other use cases. The illustrated method 400 determines 402 whether a first component of an information handling system is active and generates (404) a component active signal indicative of whether the first component is active. The illustrated method further includes configuring (406) a communication link of the information handling system based, at least in part, on the component active signal. In this manner, method 400 encompasses various scenarios in which a component may be negatively impacted by a communication link.

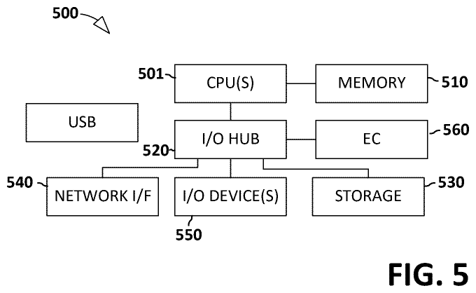

Referring now to FIG. 5, any one or more of the elements illustrated in FIG. 1 through FIG. 2 may be implemented as or within an information handling system exemplified by the information handling system 500 illustrated in FIG. 5. The illustrated information handling system includes one or more general purpose processors or central processing units (CPUs) 501 communicatively coupled to a memory resource 510 and to an input/output hub 520 to which various I/O resources and/or components are communicatively coupled. The I/O resources explicitly depicted in FIG. 5 include a network interface 540, commonly referred to as a NIC (network interface card), storage resources 530, and additional I/O devices, components, or resources 550 including as non-limiting examples, keyboards, mice, displays, printers, speakers, microphones, etc. The illustrated information handling system 500 includes an embedded controller EC 560 may provide or support various system management functions and, in at least some implementations, keyboard controller functions. Exemplary system management function that may be supported by EC 560 include thermal management functions supported by pulse width modulation (PWM) interfaces suitable for controlling system fans, power monitoring functions support by an analog-to-digital (ADC) signal that can be used to monitor voltages and, in conjunction with sense resistor, current consumption per power rail. This information could be used to, among other things, monitor battery charging or inform the user or administrator of potentially problematic power supply conditions. EC 560 may support battery management features to control charging of the battery in addition to switching between the battery and AC adapter as the active power source changes or monitoring the various battery status metrics such as temperature, charge level and overall health. EC 560 may support an Advanced Configuration and Power Interface (ACPI) compliant OS by providing status and notifications regarding power management events and by generating wake events to bring the system out of low power states.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
determining whether a first component of an information handling system is active;
generating a component active signal indicative of whether the first component is active;
configuring a communication link of the information handling system based, at least in part, on the component active signal.

2. The method of claim 1, wherein the first component comprises a global position system (GPS) receiver.

3. The method of claim 2, wherein the communication link comprises a Universal Serial Bus (USB) link.

4. The method of claim 3, wherein configuring the USB link comprises disabling USB 3.0 operation of the link.

5. The method of claim 3, wherein configuring the USB link is subject to an optimization setting prioritizing GPS performance over USB performance.

6. The method of claim 5, wherein the optimization setting is accessible via a basic input/output system (BIOS) setup interface of the information handling system.

7. The method of claim 1, wherein the first component includes an antenna configured to receive radio frequency signals.

8. The method of claim 7, wherein the antenna is proximal to a source of electrical noise associated with communication link.

9. The method of claim 8, wherein the source of electrical noise comprises a port of communication link.

10. The method of claim 1, wherein the first component is functionally unrelated with respect to the communication link.

11. An information handling system, comprising:
a central processing unit (CPU); and
a system memory, accessible to the processor, including processor executable instructions that, when executed by the CPU, cause the system to perform operations including:
determining whether a first component of an information handling system is active;
generating a component active signal indicative of whether the first component is active;
configuring a communication link of the information handling system based, at least in part, on the component active signal.

12. The information handling system of claim 1, wherein the first component comprises a global position system (GPS) receiver.

13. The information handling system of claim 12, wherein the communication link comprises a Universal Serial Bus (USB) link.

14. The information handling system of claim 13, wherein configuring the USB link comprises disabling USB 13.0 operation of the link.

15. The information handling system of claim 13, wherein configuring the USB link is subject to an optimization setting prioritizing GPS performance over USB performance.

16. The information handling system of claim 15, wherein the optimization setting is accessible via a basic input/output system (BIOS) setup interface of the information handling system.

17. The information handling system of claim 1, wherein the first component includes an antenna configured to receive radio frequency signals.

18. The information handling system of claim 17, wherein the antenna is proximal to a source of electrical noise associated with communication link.

19. The information handling system of claim 18, wherein the source of electrical noise comprises a port of communication link.

20. The information handling system of claim 11, wherein the first component is functionally unrelated with respect to the communication link.
